(19) United States
(12) Patent Application Publication
(10) Pub. No.: US 2022/0364744 A1
(43) Pub. Date: Nov. 17, 2022

(54) EASILY CLEANABLE WATERPROOF FAN AND HUMIDIFIER USING THE SAME

(71) Applicant: MIRO Co., Ltd., Incheon (KR)

(72) Inventors: Dong Jin SEO, Incheon (KR); Yong Ju OH, Incheon (KR); Min Seok KIM, Incheon (KR)

(21) Appl. No.: 17/622,523

(22) PCT Filed: Mar. 5, 2021
(86) PCT No.: PCT/KR2021/002742

§ 371 Date: Jul. 26, 2022

(30) Foreign Application Priority Data
Aug. 27, 2020 (KR) 10-2020-0108884

(51) Int. Cl. F24F 6/12; F04D 25/06; F04D 25/08; F04D 29/32; F04D 29/52; F04D 29/66

(52) U.S. Cl. CPC F24F 6/12; F04D 25/06; F04D 25/08; F04D 29/325; F04D 29/522; F04D 29/661; F24F 2006/008

(57) ABSTRACT

A waterproof fan according to an embodiment of the present invention includes: a blade module configured to be operated by a motor; and a frame having an accommodation hole that accommodates the blade module, the frame being formed to surround the accommodation hole, and the frame includes an opening that opens a part of the accommodation hole.

### TECHNICAL FIELD

The present invention relates to an easily cleanable waterproof fan and a humidifier using the same, and more particularly, to a waterproof fan, in which an opening is formed in a part of a frame of the waterproof fan, which makes it easy to clean a blade without separating the blade, and a humidifier using the same.

### BACKGROUND ART

In general, a blower fan is used as a means for pumping air by using a rotational force of an impeller or motor and used for a humidifier, a refrigerator, an air conditioner, a cleaner, or the like to introduce and discharge air.

The blower fan in the related art includes a frame having a discharge port, a motor installed at a center of the frame, and blades rotatably installed on a driving shaft of the motor. A power cable for supplying electric power is electrically connected to the motor.

The blower fan may be used for an electronic device such as a humidifier that uses water. The blower fan, which is used for the electronic device as described above, is used in a state in which gaps between the frame, the motor, and the blades, which are coupled to one another, are waterproofed. The blower fan, which is waterproofed as described above, is referred to as a waterproof fan. The waterproofed gap is increased at the time of separating the blade or the like of the waterproof fan to clean the blade or the like of the waterproof fan, which causes deterioration in waterproof performance.

### DISCLOSURE

### Technical Problem

An object of the present invention is to provide a waterproof fan, which may be easily cleaned without separating a blade module (blade) from a frame, and a humidifier using the waterproof fan.

### Technical Solution

A waterproof fan according to an embodiment of the present invention includes: a blade module configured to be operated by a motor; and a frame having an accommodation hole that accommodates the blade module, the frame being formed to surround the accommodation hole, and the frame includes an opening that opens a part of the accommodation hole.

In the embodiment of the present invention, the frame may further include a support unit provided on at least one end of the opening.

In the embodiment of the present invention, the support unit may be made of any one of silicone, synthetic rubber, natural rubber, and soft synthetic resin.

In the embodiment of the present invention, the support unit may include an embossed or debossed pattern formed on one surface thereof.

In the embodiment of the present invention, the frame may include an insertion hole, and a power cable of the motor for operating the blade module may be penetratively inserted into the insertion hole.

A humidifier according to another embodiment of the present invention includes: a floating body configured to float in a water tub that accommodates water, the floating body having a hollow portion penetratively formed vertically in a central portion thereof; an ultrasonic generator installed in the hollow portion and configured to atomize water, which is introduced into a lower portion of the ultrasonic generator, into humidification particles by using ultrasonic vibration; and a waterproof fan including a blade module configured to discharge the atomized humidification particles to the outside, the waterproof fan further includes a frame having an accommodation hole that accommodates the blade module, the waterproof fan being formed to surround the accommodation hole, and the frame includes an opening that opens a part of the accommodation hole.

In the embodiment of the present invention, the frame may further include support units provided at two opposite ends of the opening, and the ultrasonic generator may include coupling grooves to which the support units are inserted and coupled.

In the embodiment of the present invention, the support unit may include an embossed or debossed pattern formed on a lower surface thereof, the lower surface of the support unit may be in contact with the coupling groove, and a contact region between the lower surface of the support unit and the coupling groove may have a linear shape.

A humidifier according to still another embodiment of the present invention includes: a floating body configured to float in a water tub that accommodates water, the floating body having a hollow portion penetratively formed vertically in a central portion thereof; an ultrasonic generator installed in the hollow portion and configured to atomize water, which is introduced into a lower portion of the ultrasonic generator, into humidification particles by using ultrasonic vibration; and a waterproof fan including a blade module configured to discharge the atomized humidification particles to the outside, the waterproof fan further includes a frame having an accommodation hole that accommodates the blade module, the waterproof fan being formed to surround the accommodation hole, and the frame includes: an opening that opens a part of the accommodation hole; and an insertion hole into which a power cable of the waterproof fan and a power cable of the ultrasonic generator are penetratively inserted.

Other detailed matters of the embodiment are included in the detailed description and the accompanying drawings.

### Advantageous Effects

According to the waterproof fan according to the embodiment of the present invention, it is possible to easily clean the blade without separating the blade module and the frame.

The waterproof fan according to the embodiment of the present invention may attenuate vibration generated by the motor while having the opening that makes it easy to clean the waterproof fan.

### DESCRIPTION OF DRAWINGS

FIG. 1A is a front view illustrating an easily cleanable waterproof fan according to an embodiment of the present invention.

FIG. 1B is a front perspective view illustrating the easily cleanable waterproof fan according to the embodiment of the present invention.

FIG. 1C is a rear perspective view illustrating the easily cleanable waterproof fan according to the embodiment of the present invention.

FIG. 1D is a rear view illustrating the easily cleanable waterproof fan according to the embodiment of the present invention.

FIG. 1E is a rear view illustrating an easily cleanable waterproof fan according to another embodiment of the present invention.

FIG. 2A is a front perspective view illustrating a blade module according to the embodiment of the present invention.

FIG. 2B is a rear perspective view illustrating the blade module according to the embodiment of the present invention.

FIG. 3 is a perspective view illustrating a frame according to the embodiment of the present invention.

FIG. 4A is a front view illustrating an example of a support unit according to the embodiment of the present invention.

FIG. 4B is a top plan view illustrating the support unit according to the embodiment of the present invention when viewed from below.

FIG. 5 is a perspective view illustrating a humidifier using the easily cleanable waterproof fan according to the embodiment of the present invention.

FIG. 6 is an exploded perspective view illustrating the humidifier according to the embodiment of the present invention.

FIG. 7 is a perspective view illustrating the humidifier from which an upper casing illustrated in FIG. 5 is excluded.

### MODE FOR INVENTION

Advantages and/or features of the present invention and methods of achieving the advantages and features will be clear with reference to embodiments described in detail below together with the accompanying drawings. However, the present invention is not limited to the embodiments disclosed herein but will be implemented in various forms. The embodiments of the present invention are provided so that the present invention is completely disclosed, and a person with ordinary skill in the art to which the present invention pertains can fully understand the scope of the present invention. the present invention will be defined only by the scope of the appended claims. Like reference numerals indicate like constituent elements throughout the specification.

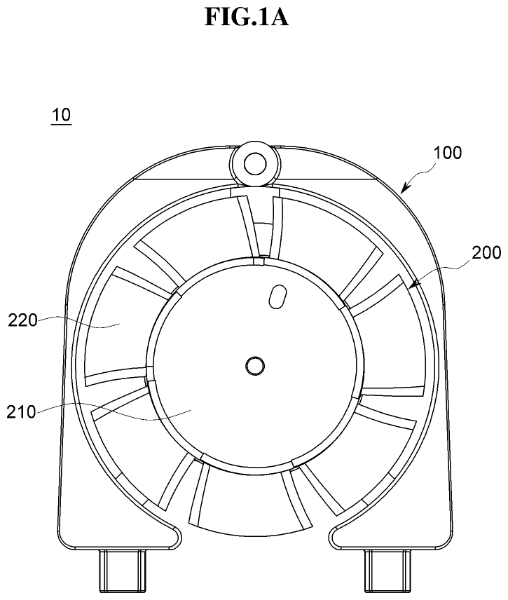

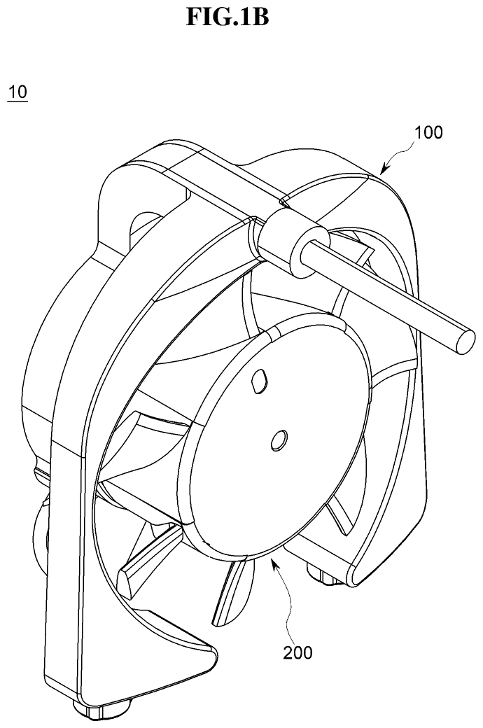

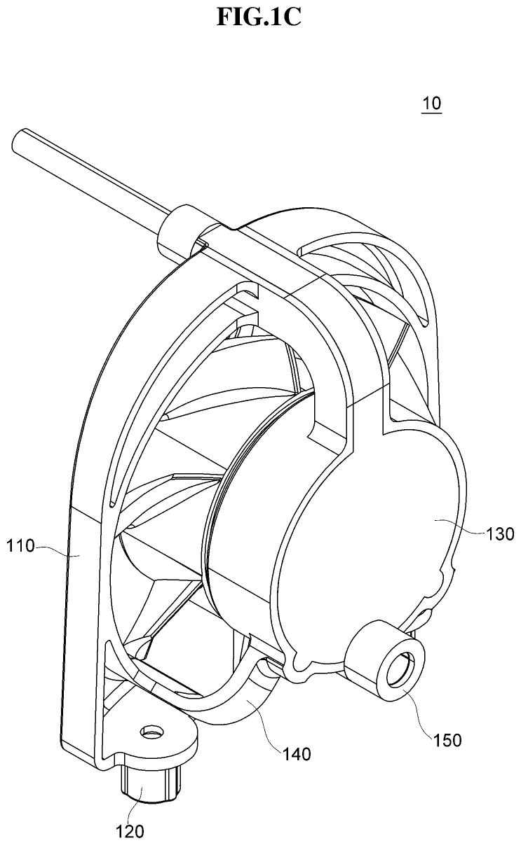

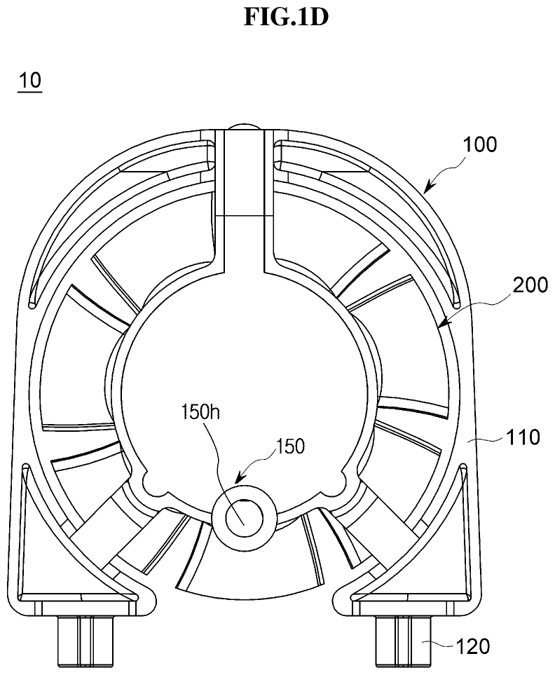

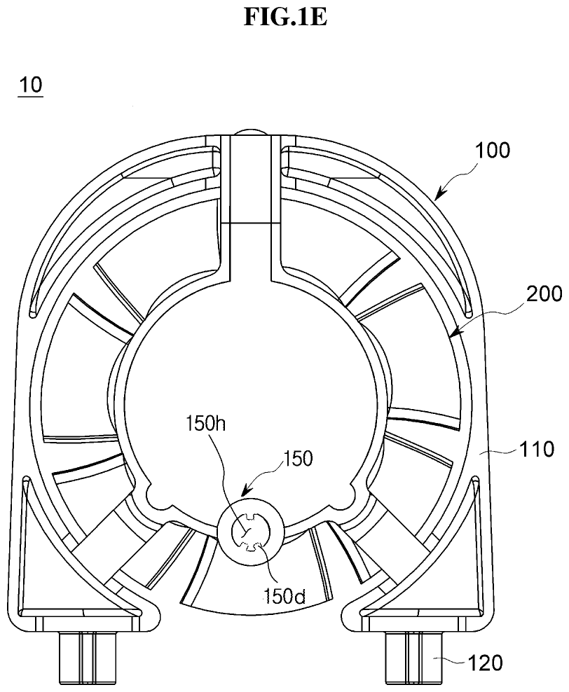

FIGS. 1A, 1B, 1C, and 1D are a front view, a front perspective view, a rear perspective view, and a rear view illustrating an easily cleanable waterproof fan according to an embodiment of the present invention. FIG. 1E is a rear view illustrating an easily cleanable waterproof fan according to another embodiment of the present invention.

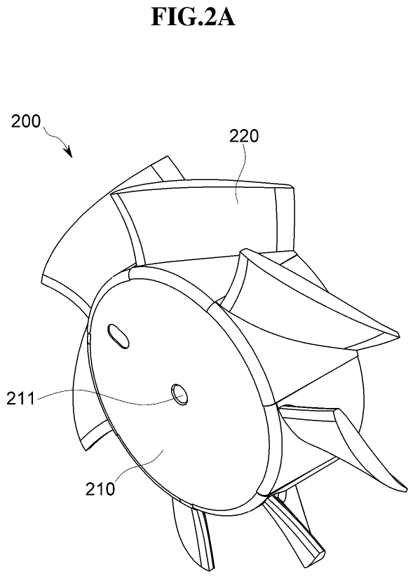

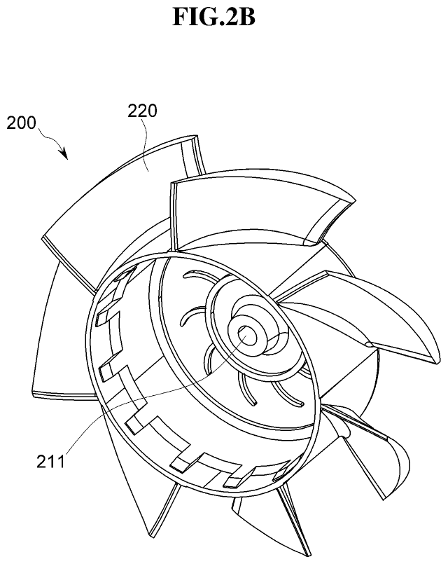

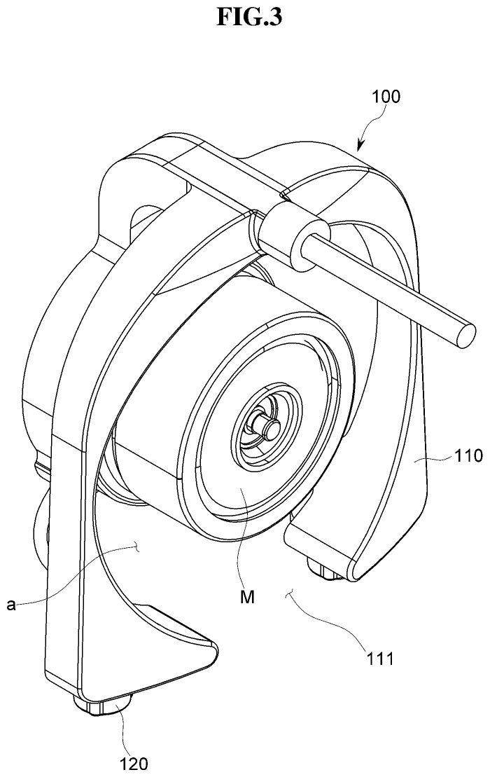

FIG. 2A is a front perspective view illustrating a blade module according to the embodiment of the present invention, FIG. 2B is a rear perspective view illustrating the blade module according to the embodiment of the present invention, and FIG. 3 is a perspective view illustrating a frame according to the embodiment of the present invention.

Referring to FIGS. 1A, 1B, 1C, and 1D to 2, the easily cleanable waterproof fan according to the present invention is an axial fan and includes a blade module 200 including a plurality of blades and a frame 100. The blade module 200 may be waterproofed by being coupled to the frame 100.

Referring to FIGS. 2A and 2B, the blade module 200 includes a hub 210 provided at a center thereof, and a plurality of blades 220 disposed at predetermined intervals along an outer peripheral surface of the hub 210. The blade module 200 is coupled to a rotary shaft of a drive motor M (not illustrated) and configured to rotate when the drive motor M operates.

The hub 210 may accommodate the drive motor M at a center thereof and has a coupling hole 211 to which the rotary shaft of the drive motor M is coupled. The drive motor M is accommodated at the center of the hub 210, and the rotary shaft is inserted into and fastened to the coupling hole 211. Therefore, when the rotary shaft of the drive motor M rotates, the hub 210 and the plurality of blades 220 rotate. The hub 210 and the blades 220 may be integrated.

Referring to FIGS. 1A, 1B, 1C, and 1D to 3, the frame 100 defines a space a (hereinafter, referred to as an ‘accommodation hole’) that accommodates the blade module 200. The frame 100 defines an entire external shape of the waterproof fan 10.

The frame 100 may include a body 110, support units 120, a fixing unit 130, spokes 140, and an insertion tube 150.

The body 110 has a frame shape that surrounds the blade module 200, and the interior surrounded by the frame shape defines the space a (hereinafter, referred to as the ‘accommodation hole’) that accommodates the blade module 200. Although not illustrated, the frame 100 may be a frame having a circular shape, a quadrangular shape, a polygonal shape, and the like. The accommodation hole a may be used as a space in which the blade module 200 is accommodated, i.e., a space in which the blade module 200 is installed and rotated. The accommodation hole may be penetratively formed so that air may pass through the accommodation hole.

Therefore, the accommodation hole a may be formed to have a diameter relatively larger than an overall diameter of the blade module 200 to allow the blade module 200 to operate smoothly.

The body 110 may have an opening 111 made by opening a part of the accommodation hole a. The accommodation hole a has a structure opened by the opening 111. That is, the blade 220 may be cleaned through the opening 111 of the body 110 without separating the blade module 200 and the body 110. The opening 111 may be formed to have a size smaller than a rotation diameter of the blade 220.

The body 110 further includes the support units 120 to prevent rattling or noise that may occur because of the opening 111.

The support unit 120 may be configured as an elastic body for preventing rattling or noise that may occur because of the operation of the blade module 200. The support unit 120 may be disposed on at least one end of the opening 111 of the body 110. The support unit 120 is made of any one of silicone, synthetic rubber, natural rubber, and soft synthetic resin.

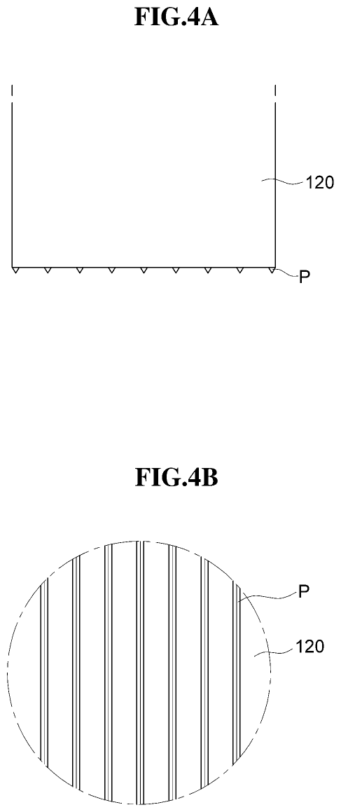

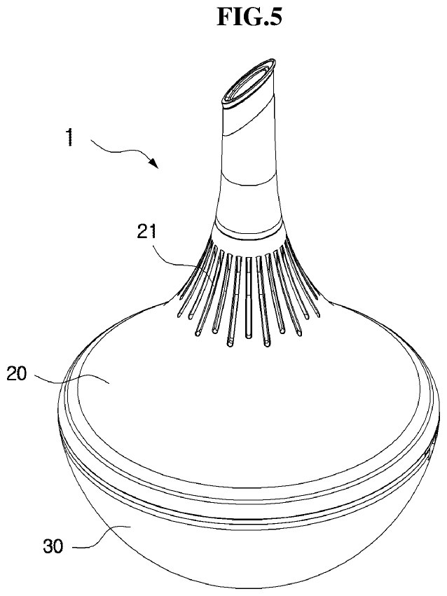

FIG. 4A is a front view illustrating an example of the support unit according to the embodiment of the present invention, and FIG. 4B is a top plan view illustrating the support unit according to the embodiment of the present invention when viewed from below. Referring to FIGS. 4A and 4B, a surface of the support unit 120, which is in contact with an electronic device, is a discontinuous contact surface having one or more non-contact portions or a single coupling surface of the support unit 120 may be in line contact with the electronic device. The support unit 120 has a polygonal shape having a debossed or embossed pattern P when viewed from below, and one or more surfaces of the support unit 120 may be in line contact with the electronic device by means of the pattern P. The shape of the pattern P is not limited. A contact area with the electronic device is reduced by the support unit 120 having the pattern P, which makes it possible to attenuate vibration in a vertical direction which is generated by the motor and transmitted to the electronic device.

Referring back to FIGS. 1A, 1B, 1C, and 1D to 3, the fixing unit 130 is disposed at a position corresponding to the accommodation hole of the blade module 200 (see FIG. 2B) and fixes a rear end of the drive motor M for operating the blade module 200. That is, a rotation axis of the blade module 200, a rotation axis of the drive motor M, and a central axis of the fixing unit 130 are coincident with one another.

The spokes 140 fix the fixing unit 130 to the body 110. For example, the spokes 140 are radially disposed and connect and support the fixing unit 130 to the body 110. Three spokes 140 are illustrated, but the present invention is not limited thereto.

The insertion tube 150 is provided on a rear surface of the fixing unit 130 and used for a power cable for supplying electric power to the drive motor M. An insertion hole 150h may be penetratively formed forward and rearward in the insertion tube 150 and extend toward a rear side of frame 100. The insertion tube 150 may be, but not limited to, a cylindrical tubular body having a circumference in a horizontal direction. The insertion hole 150h may have a diameter larger than a longitudinal thickness of the power cable so that the power cable is penetratively coupled smoothly. Further, the insertion hole 150h may have a shape corresponding to a shape of the power cable. When a horizontal cross-section of the power cable has a circular shape, the insertion hole 150h may also have a circular shape corresponding to the shape of the power cable.

In addition, the insertion hole 150h may be formed to press and support an outer periphery of the power cable so that the power cable is not moved in the insertion hole 150h or withdrawn to the outside.

In addition, the insertion tube 150 may have a tapered shape having a diameter that gradually increases toward the rear surface of the frame 100 in order to increase coupling strength.

In this case, various diameters and shapes of the insertion tube 150 may be applied. The insertion tube 150 may be a tubular body with a horizontal cross-section having any one of a single circular shape, a single elliptical shape, a single polygonal shape, a plurality of circular shapes, a plurality of elliptical shapes, and a plurality of polygonal shapes. As illustrated in FIG. 1E, the insertion tube 150 may include one or more protrusions 150d protruding from an inner periphery thereof toward a center of the insertion hole. The protrusions may auxiliary press and support the outer periphery of the power cable inserted into the insertion hole 150h. The plurality of protrusions may be disposed on the inner periphery of the insertion tube 150. In a case in which the protrusions are positioned to face one another at opposite sides, the protrusions may respectively support, in two directions, two opposite ends of the power cable penetratively coupled in the insertion hole. According to the embodiment of the present invention, the easily cleanable waterproof fan may be installed in a humidifier. In this case, the humidifier may be a floating humidifier.

The floating humidifier according to the embodiment of the present invention floats at a predetermined height in a water tub, converts water introduced thereinto into water particles by using ultrasonic waves, and then discharges the water particles in an atomized state by using a blower fan (waterproof fan).

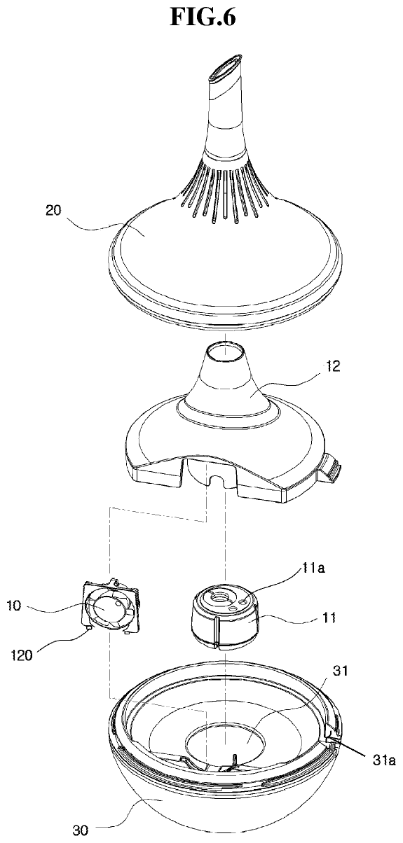

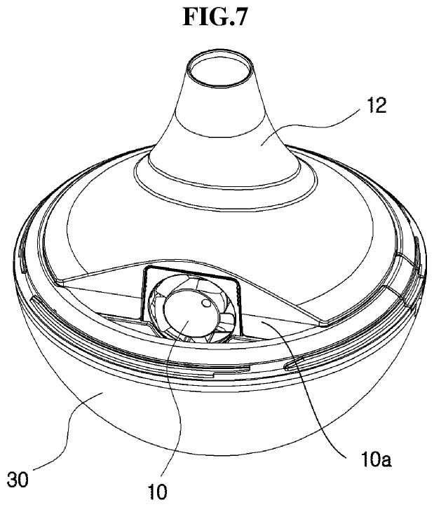

FIG. 5 is a perspective view illustrating the humidifier using the easily cleanable waterproof fan according to the embodiment of the present invention, FIG. 6 is an exploded perspective view illustrating the humidifier according to the embodiment of the present invention, and FIG. 7 is a perspective view illustrating the humidifier from which an upper casing illustrated in FIG. 5 is excluded. As illustrated in FIG. 7, the humidifier from which the upper casing is excluded in FIG. 7 is partially opened to show the waterproof fan.

Referring to FIGS. 5 to 7, a floating humidifier 1 may include the waterproof fan 10, an ultrasonic generator 11, a humidification particle guide unit 12, an upper casing 20, and a floating body 30.

The floating body 30 floats in the water tub that accommodates water. The floating body 30 has a hollow portion 31 penetratively formed in a central portion thereof.

In this case, the floating body 30 may include a lower body having a buoyancy space formed along an inner rim thereof so that the floating body 30 may float in the water, and an upper body coupled to an upper portion of the lower body. Therefore, the buoyancy space for generating buoyancy may be formed in the floating body 30.

Further, the floating body 30 may have a shape having a narrow lower side and a diameter that gradually increases toward an upper side thereof. However, the present invention is not limited thereto, and the floating body 30 may have various shapes.

In addition, an inlet port may be formed in a lower portion of the floating body 30 so that water may be introduced into the inlet port. The hollow portion 31 may communicate with the inlet port along an upper side of the inlet port.

The ultrasonic generator 11 may be installed in the hollow portion 31 of the floating body 30 and atomize the water, which is introduced into the lower portion of the floating body 30, into humidification particles by using ultrasonic vibration. Further, the ultrasonic generator 11 may discharge the humidification particle in a direction perpendicular to a center of the hollow portion 31.

Because the waterproof fan 10 is identical to the above-mentioned waterproof fan, a description of detailed configurations thereof will be omitted.

In this case, the waterproof fan 10 may be coupled to the ultrasonic generator 11.

To this end, a coupling groove 11a may be provided in one surface of the ultrasonic generator 11, and the support unit 120 of the waterproof fan 11 may be inserted into and coupled to the coupling groove 11a.

The support unit 120 of the waterproof fan 10 may be in contact with the coupling groove 11a by means of the debossed or embossed pattern formed on the lower surface coupled to the coupling groove 11a as described above, and a contact region between the support unit 120 and the coupling groove 11a has a linear shape, thereby preventing the vertical vibration, which is generated by the operation of the drive motor for operating the waterproof fan 10, from being transmitted to the ultrasonic generator 11. In another modified example, a debossed or embossed pattern may also be formed on a lateral surface of the support unit 120.

In this case, a separate power cable may be connected to the ultrasonic generator 11 or the waterproof fan 10 to be described below, and the connected power cable may be inserted into the insertion hole (150h in FIG. 1D) of the insertion tube (150 in FIG. 1D) provided on the frame (100 in FIG. 1D) of the waterproof fan 10 and penetrate the frame (100 in FIG. 1D). The power cable having passed through the frame (100 in FIG. 1D) may extend to the outside through the cable hole 31a of the floating body 30.

The humidification particle guide unit 12 is installed on an upper portion of the floating body 30 and has a hole that communicates with the outside. The humidification particle guide unit 12 may guide the humidification particles so that the humidification particles move upward along the hole in the humidification particle guide unit 12.

The humidification particle guide unit 12 may be installed above the hollow portion 31 of the floating body 30, and particularly, positioned above the ultrasonic generator 11.

In addition, the hole may have a shape having a diameter that gradually decreases upward. A discharge port may be penetratively formed toward the outside at an upper end of the hole.

The humidification particle guide unit 12 may have an intake port 10a formed at a position at which the waterproof fan 10 is disposed. The waterproof fan 10 may move outside air into the humidifier through the intake port 10a.

The upper casing 20 may be detachably coupled to an upper end of the floating body 30 and have a gourd bottle shape having an outer diameter that gradually decreases from the lower end to the upper end.

Further, a plurality of air inlet holes 21, through which outside air is introduced, may be formed in an outer surface of the upper end of the upper casing 20 and disposed at predetermined intervals.

Further, a cap (not illustrated) may be provided on the upper end of the upper casing 20 and control the diffusion amount and the diffusion direction of the humidification particles generated by the ultrasonic generator 11. The cap (not illustrated) may further have a diffusion hole (not illustrated) through which the water particle or moisture vapor is discharged. In this case, the water particle or moisture vapor means the humidification particle.

The floating humidifier having the waterproof fan according to the embodiment of the present invention is formed such that the respective components are easily separated and cleaned. In particular, the waterproof fan is formed to make it easy to clean the blades without separating the blade module and the frame.

While the specific embodiments according to the present invention have been described above, various modifications may be made without departing from the scope of the present invention. Therefore, the scope of the present invention should not be limited to the described embodiments, and should be defined by not only the claims to be described below, but also those equivalent to the claims.

While the present invention has been described above with reference to the limited embodiments and the drawings, the present invention is not limited to the embodiments and may be variously modified and altered from the disclosure by those skilled in the art to which the present invention pertains. Therefore, the spirit of the present invention should be defined only by the appended claims, and all modifications, equivalents, and alternatives fall within the scope and spirit of the present invention.

### DESCRIPTION OF REFERENCE NUMERALS

10: Waterproof fan
100: Frame
110: Body
120: Support unit
130: Fixing unit
140: Spoke
150: Insertion tube
200: Blade module
210: Hub
220: Blade

1. A waterproof fan comprising:
a blade module configured to be operated by a motor; and
a frame having an accommodation hole that accommodates the blade module, the frame being formed to surround the accommodation hole,
wherein the frame comprises an opening that opens a part of the accommodation hole.

2. The waterproof fan of claim 1, wherein the frame further comprises a support unit provided on at least one end of the opening.

3. The waterproof fan of claim 2, wherein the support unit is made of any one of silicone, synthetic rubber, natural rubber, and soft synthetic resin.

4. The waterproof fan of claim 2, wherein the support unit comprises an embossed or debossed pattern formed on one surface thereof.

5. The waterproof fan of claim 1, wherein the frame comprises an insertion hole, and a power cable of the motor for operating the blade module is penetratively inserted into the insertion hole.

6. A humidifier comprising:
a floating body configured to float in a water tub that accommodates water, the floating body having a hollow portion penetratively formed vertically in a central portion thereof;
an ultrasonic generator installed in the hollow portion and configured to atomize water, which is introduced into a lower portion of the ultrasonic generator, into humidification particles by using ultrasonic vibration; and
a waterproof fan comprising a blade module configured to discharge the atomized humidification particles to the outside,
wherein the waterproof fan further comprises a frame having an accommodation hole that accommodates the blade module, the waterproof fan being formed to surround the accommodation hole, and
wherein the frame comprises an opening that opens a part of the accommodation hole.

7. The humidifier of claim 6, wherein the frame further comprises support units provided at two opposite ends of the opening, and the ultrasonic generator comprises coupling grooves to which the support units are inserted and coupled.

8. The humidifier of claim 7, wherein the support unit is made of any one of silicone, synthetic rubber, natural rubber, and soft synthetic resin.

9. The humidifier of claim 7, wherein the support unit comprises an embossed or debossed pattern formed on a lower surface thereof, the lower surface of the support unit is in contact with the coupling groove, and a contact region between the lower surface of the support unit and the coupling groove has a linear shape.

10. A humidifier comprising:
a floating body configured to float in a water tub that accommodates water, the floating body having a hollow portion penetratively formed vertically in a central portion thereof;
an ultrasonic generator installed in the hollow portion and configured to atomize water, which is introduced into a lower portion of the ultrasonic generator, into humidification particles by using ultrasonic vibration; and
a waterproof fan comprising a blade module configured to discharge the atomized humidification particles to the outside,
wherein the waterproof fan further comprises a frame having an accommodation hole that accommodates the blade module, the waterproof fan being formed to surround the accommodation hole, and
wherein the frame comprises:
an opening that opens a part of the accommodation hole; and
an insertion hole into which a power cable of the waterproof fan and a power cable of the ultrasonic generator are penetratively inserted.

11. The humidifier of claim 10, comprising:
an insertion tube penetratively formed forward and rearward in the insertion hole and extending toward a rear side of the frame,
wherein the insertion tube is a tubular body having a horizontal cross-section having any one of a single circular shape, a single elliptical shape, a single polygonal shape, a plurality of circular shapes, a plurality of elliptical shapes, and a plurality of polygonal shapes, and
wherein the insertion tube comprises one or more protrusions protruding from an inner periphery thereof toward a center of the insertion hole.

12. The humidifier of claim 10, wherein the insertion hole is formed to correspond to a shape of a horizontal cross-section of the power cable.
